(19) United States
(12) Patent Application Publication
(10) Pub. No.: US 2026/0180861 A1
(43) Pub. Date: Jun. 25, 2026

(54) Managing Configuration Using Configuration Fragments

(71) Applicant: Arista Networks, Inc., Santa Clara, CA (US)

(72) Inventors: Hua ZHONG, Los Altos, CA (US); Itthichok JANGJAIMON, San Jose, CA (US); Michael GREENWALD, Berkeley, CA (US); Rehmaan MOMIN, Leander, TX (US); Diego Alfredo ASTURIAS, Santa Clara, CA (US)

(21) Appl. No.: 18/987,956

(22) Filed: Dec. 19, 2024

(51) Int. Cl. H04L 41/0873; H04L 41/0803

(52) U.S. Cl. CPC H04L 41/0873; H04L 41/0803

(57) ABSTRACT

A user updates portions of the running configuration of a network device referred to as configuration fragments. Configuration fragment operations are provided to facilitate the user's effort, including identifying conflicts between fragments, computing differences between fragments and merging fragments. When the user commits modified fragments to the running configuration, the network device merges the modified fragments to produce a union configuration and determines a difference between the running configuration and the union configuration. The difference operation generates a set of configuration commands, which when executed update the running configuration to the union configuration.

### CROSS REFERENCE TO RELATED APPLICATIONS

This application is related to U.S. app. Ser. No. 18/071,826, filed Nov. 30, 2022, entitled “Merging Configurations of Network Devices” and U.S. app. Ser. No. 18/620,589, filed Mar. 28, 2024, entitled “Managing Network Device Configurations Based on Configuration Fragments,” the content of both which is incorporated herein by reference in its entirety for all purposes.

### BACKGROUND

The present disclosure is directed to updating the running configuration in a network device. The configuration of a network device controls the flow of packets in a network, such as a router or switch, and can be quite intricate, comprising thousands (or more) of individual features. Typically the configuration of these individual features can be accomplished through interaction with an interface (e.g., command line interface, CLI, web access and so on) of the network device. A user can input configuration commands (or simply “commands”) for configuring one or more features through the interface and the features may be configured accordingly at the network device. Alternatively, the commands can be stored in a file (script) that can then be processed (e.g., by the network device, a network controller, etc.) to configure the network device.

The running configuration represents the current settings and values of the hardware (e.g., interfaces, data lanes, clocks, etc.) and data tables (e.g., lookup tables, access control lists, etc.) of the network device (collectively referred to as features of the network device), and refers to the set of configuration commands used to configure the network device with those settings and values. The running configuration in a network device can be accessed by a user, allowing the user to view/update the configuration. Currently, there are two ways to update the running configuration:
A user can execute commands on top of the running configuration to add, modify, or remove a given configuration. However, this can result in an indeterminate operating state in the network device due to its dependency on the previous configuration.
Alternatively, the user can replace the entire running configuration with a new configuration and execute the new configuration. Executing the entire configuration and causing all the hardware and data tables of the network device to be configured disrupts traffic flow. This can be inefficient, especially if only a few updates are made to the current running configuration. For example, the current configuration may contain 100's of configuration commands, while an update may involve changing or adding only a few configuration commands.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a high level representation of a network device in accordance with the present disclosure.

FIG. 2 shows details of handling configuration fragments in accordance with the present disclosure.

FIG. 3 shows additional details of handling configuration fragments in accordance with the present disclosure.

FIGS. 4A and 4B are illustrative examples of a configuration and configuration fragments in accordance with the present disclosure.

FIG. 5 is an illustrative example of a configuration tree and some examples of configuration fragments in accordance with the present disclosure.

FIG. 6 is a high level flow of processing in accordance with the present disclosure.

FIG. 7 shows an example of a configuration fragment in accordance with the present disclosure.

FIGS. 8A and 8B illustrate examples of merging configuration fragments to produce a merged fragment in accordance with the present disclosure.

FIG. 9 shows an example of details of a network device in accordance with the present disclosure.

### DETAILED DESCRIPTION

In accordance with embodiments of the present disclosure, a user can update the running configuration in a network device in units of data referred to as configuration fragments (“fragments”). The running configuration refers to both the actual settings in the network device (hardware, data tables, etc.) and the configuration commands specified by a user (human user, machine user, data files, etc.) that are executed to configure the network device with those settings. A configuration fragment basically refers to a set of configuration commands. In one context, a configuration fragment can refer to the series of configuration commands entered by a user. In another context, the configuration fragment can refer to a set of configuration commands that represents a portion or a subset of the running configuration.
The user can specify one or more fragments of the running configuration for modification; in some embodiments, for example, fragments can be identified by name. When the user specifies a configuration fragment that does not exist, the response can be to create an empty fragment.
The user can edit/modify copies of the fragments.
The user can commit the modified fragments—this operation “installs” the modified fragments in the running configuration by updating the current settings of the hardware (e.g., interfaces, data lanes, clocks, etc.) and data tables (e.g., lookup tables, access control lists, etc.) of the network device according to the modified fragments.

In accordance with the present disclosure, committing the modified fragments to the running configuration includes:
checking for conflicts among the modified fragments
merging the modified fragments into a single configuration (the union configuration)
calculate a difference between the running configuration and the union configuration to generate configuration commands that can change the running configuration to the union configuration
running the generated configuration commands to convert the running configuration to the union configuration

Embodiments in accordance with the present disclosure allow a user to modify portions of the running configuration of the network device without having to re-execute the entire configuration, thus reducing the disruption of traffic through the network device. Embodiments in accordance with the present disclosure allow multiple users to modify different parts of the running configuration. The conflict check identifies and flags conflicts that may arise when multiple independent users concurrently access and modify the running configuration. Because conflicts are identified and opportunity is provided to correct the conflicts, portions of the running configuration can be updated by any number of users in a predictable manner without unexpected impact on remaining portions of the running configuration. Configuration commands generated by the differ operation can be used to automate updating the running configuration over to the new configuration.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

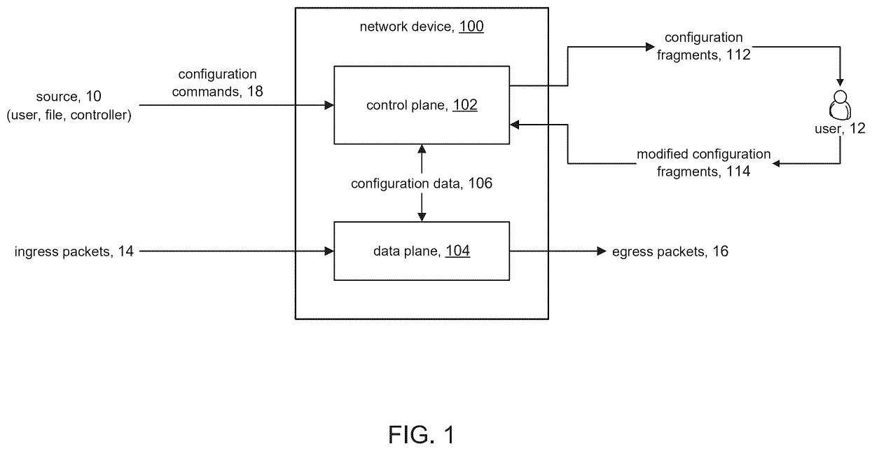

FIG. 1 is an illustrative block diagram representing a network device in accordance with the present disclosure. Network device 100 includes a control plane 102 and a data plane 104. Data plane 104 can be adapted to receive packets (ingress packets 14) via ports (not shown) of network device 100, process the packets, and route or otherwise forward packets (egress packets 16) via the ports.

Control plane 102 can be adapted to manage the operation of network device 100. For example, control plane 102 can receive configuration commands 18 to configure data plane 104. Configuration commands 18 can generate configuration data 106 to configure the hardware (e.g., interfaces, data lanes, clocks, etc.) and data tables (e.g., lookup tables, access control lists, etc.) in data plane 104 for packet routing and forwarding. Configuration commands 18 can come from source 10 such as a human user, a configuration file or script, a network controller, and so on.

In accordance with the present disclosure, control plane 102 can include functionality to allow a user 12 (human user, machine user, data files, etc.) to edit the running configuration in network device 100. The running configuration refers to the current configuration or settings in the hardware and data tables in network device 100, such as user names, passwords, port/interface definitions, hardware settings, routing and/or forwarding table entries, and the like. In accordance with the present disclosure, control plane 102 can expose portions of the running configuration to a user in data units referred to as configuration fragments. FIG. 1 shows an example of user 12 accessing configuration fragments 112. The user can edit the configuration fragments and provide modified configuration fragments 114 to control plane 102 to be combined with the running configuration.

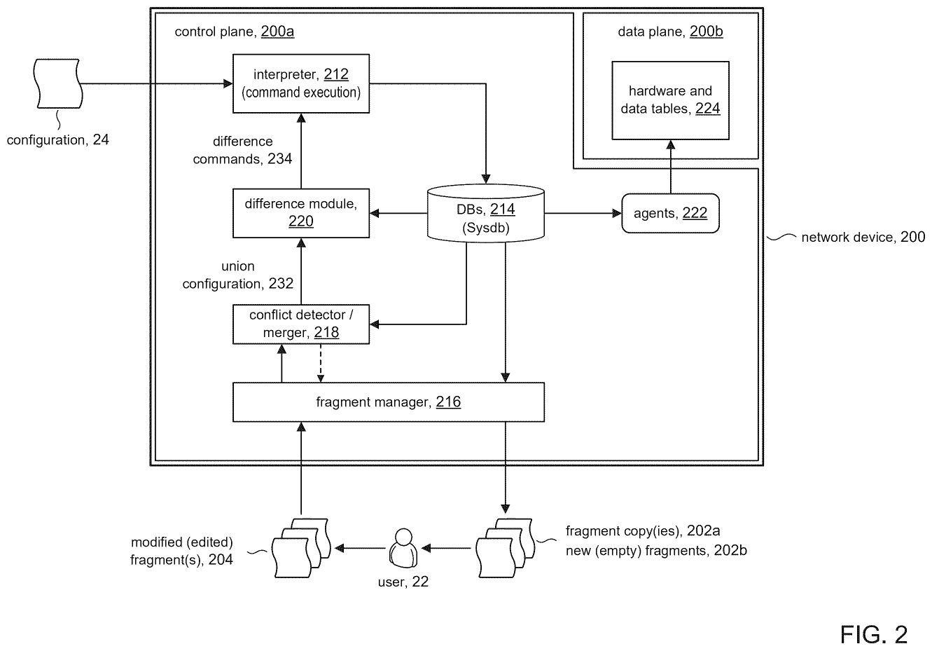

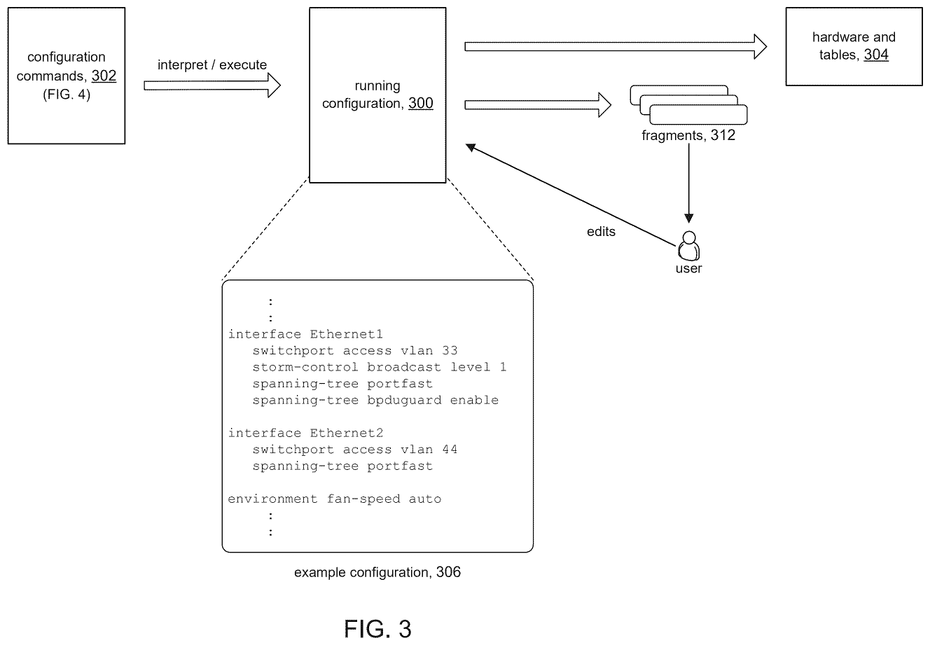

FIG. 2 shows additional detail of a network device in accordance with the present disclosure. Network device 200, includes control plane 200a and data plane 200b. Control plane 200a includes command interpreter 212 which executes configuration commands to generate configuration data that is stored in one or more system databases (Sysdb) 214. System databases 214 store the running configuration of network device 200, including subsets of the configuration commands (fragments 312, FIG. 3) that constitute the running configuration. Agents 222 read configurations stored in system databases 214 to program elements 224 in data plane 200b such as interfaces, data lanes, clocks, and the like, (collectively hardware) and lookup tables, access control lists, and the like (collectively data tables).

Network device 200 can be initially configured by configuration commands in configuration 24; for example, when the network device is initially deployed. In some embodiments, initial configuration 24 can be stored in a data file that is downloaded to the network device 200, executed by command interpreter 212, and stored in system databases 214 to be programmed into the hardware and data table 224 by agents 222. For example, initial configuration 24 can be provided to network device 200 from a network controller (not shown).

In accordance with the present disclosure, control plane 200a includes fragment manager module 216 to manage the running configuration of network device 200 during operation of the network device. Fragment manager 216 serves as an interface to provide user 22 (human user, machine user, data files, etc.) with access to the running configuration in system databases 214 by exposing portions of the running configuration to the user in data units referred to as “configuration fragments,” or simply fragments. Fragment manager 216 can provide user 22 with copies 202a of fragments of the running configuration, allowing the user to make changes to the running configuration. Fragment manager 216 can also create new (empty) fragments 202b, allowing the user to add configurations to the running configuration (e.g., to configure a new interface on the network device).

Modified fragments 204 can be provided to conflict detector/merger module 218 via fragment manager 216 to begin updating the running configuration. In accordance with some embodiments, module 218 checks for conflicts between modified fragments 204. Conflicts can be flagged, allowing for the user to correct the conflicts. Module 218 can merge together modified fragments 204 to produce a union configuration 234 that represents the modified fragments.

Difference module 220 computes differences between the running configuration and union configuration 232 and generates a configuration command set 234 comprising configuration commands that will change only those portions of the running configuration to match the state of the union configuration. The configuration command set 234 can then be provided to command interpreter 212 to reprogram network device 200.

Referring to FIG. 3, running configuration 300 represents the running configuration for a network device (e.g., 100). Running configuration 300 comprises information for configuring the hardware and data tables 304 in the network device. Merely for illustration, FIG. 3 shows an example configuration 306 in running configuration 300. The example configuration 306 includes interface-specific configuration entries for interfaces Ethernet1 and Ethernet2. The example configuration 306 also shows an example of a global configuration entry that applies to the network device itself, namely a fan-speed setting. It will be appreciated that running configuration 300 can include many hundreds of configuration entries to configure a network device for proper operation.

The running configuration 300 can be established or otherwise created by configuration commands 302. In some embodiments, for example, configuration commands 302 can be submitted (e.g., in a configuration file) to the network device by a machine user, for example, a central network controller or by a human user via a suitable CLI (command line interface) running on the network device.

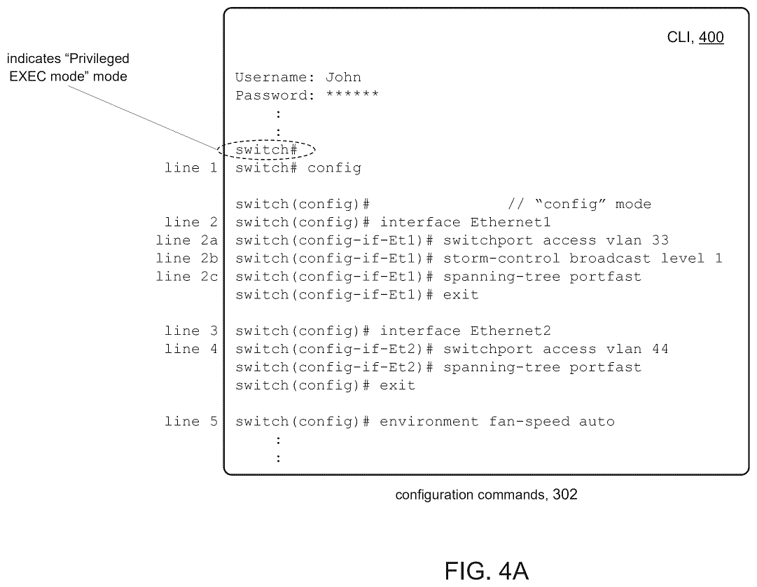

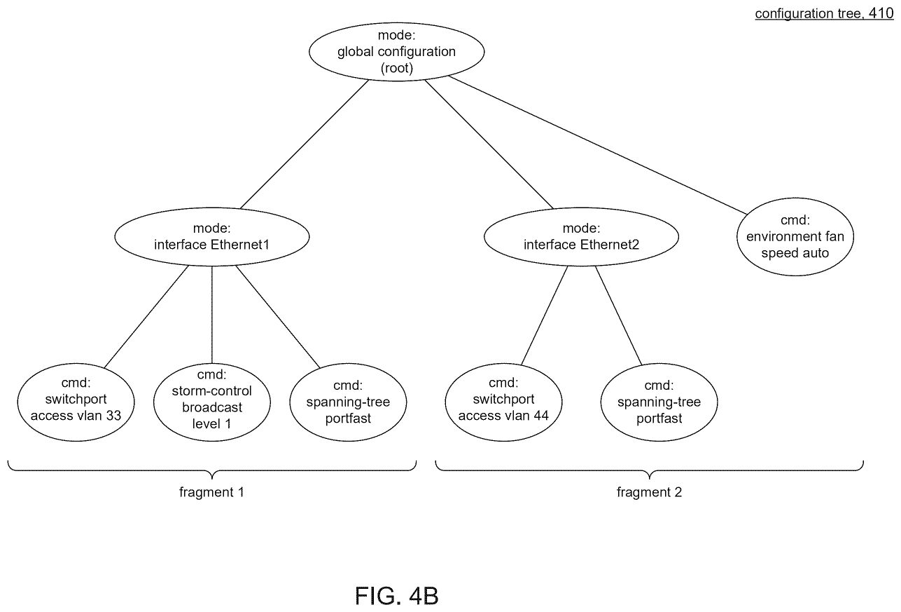

FIG. 4A shows an example of configuration commands 302 to generate the example configuration 306 shown in FIG. 3. Configuration commands 302 can be entered into the network device via a CLI 400. The figures show some of the configuration commands 302 entered via CLI 400. Merely for discussion purposes, the CLI example is based on a CLI used in the EOS® (Extensible Operating System) network operating system developed and sold/licensed by Arista Networks, Inc. of Santa Clara, California. It will be appreciated of course that embodiments of the present disclosure can use any interface on any network operating system. It will also be appreciated that the CLI command set and the grammar and syntax of the CLI command set can vary from one embodiment to another.

In some embodiments, CLI 400 provides command modes that define user interface (UI) states, where each command mode is associated with commands for configuring a component of the network device. For example, CLI 400 shows a command mode referred to as the interface configuration mode to configure parameters of a specified interface on the network device. CLI 400 shows the user enters a mode at line 2 called “interface Ethernet1” for configuring the Ethernet1 interface, and likewise the user enters a mode at line 3 called “interface Ethernet2” for configuring the Ethernet2 interface. CLI 400 includes other configuration modes such as an ACL (access control list) configuration mode that allows the user to configure ACL tables on the network device, a router BGP (border gate protocol) configuration mode that allows the user to configure BGP to learn routes, and so on.

CLI 400 includes a global configuration mode to configure features at the network device level, such as system time, the device name, and so on. For example, the CONFIG command (line 1) places CLI 400 in a global configuration mode and the configuration command at line 5 sets the fan speed operation for the network device. For example, the INTERFACE ETHERNET1 command (line 2) places CLI 400 in the interface configuration mode to configure interface Ethernet1. Various configuration commands (lines 2a-2c) can be entered to configure interface Ethernet1. The prompt indicates the nesting of command modes; for example, the prompt at line 2 a indicates “interface Ethernet 1” mode is a sub-mode under the “configuration” mode, and the configuration mode is a sub-mode under a mode referred to as “Privileged EXEC mode” mode.

The full set of configuration commands (e.g., 302) to configure the running configuration (300) on a network device can be represented in a tree data structure. The tree represents the configuration modes and the configuration commands executed in each mode. FIG. 4B shows an example of a configuration tree 410 that represents the configuration commands shown in the example CLI 400. The global configuration mode can serve as the root node in tree 410. The non-leaf nodes represent command modes (sub-modes under the global configuration mode) and the leaf nodes represent the configuration commands. The two non-leaf nodes represent the command modes, namely interface Ethernet1 and interface Ethernet2, and the leaf nodes contain the configuration command sequence (one or more configuration commands) entered in each mode. Although the leaf node examples shown herein contain one command, it will be appreciated that in general a leaf node can contain more than one command when the commands belong to the same feature and are considered related.

The discussion will now turn to a description of configuration fragments (e.g., 312) in accordance with the present disclosure. Generally, a configuration fragment is a collection of one or more configuration commands. More specifically in accordance with the present disclosure, a configuration fragment comprises the configuration commands that constitute a portion (or a subset) of the running configuration of the network device. A configuration fragment is associated with a subset of the configurable elements (hardware, data tables, etc.) of the network device and comprises one or more configuration commands to configure the subset of the configurable elements.

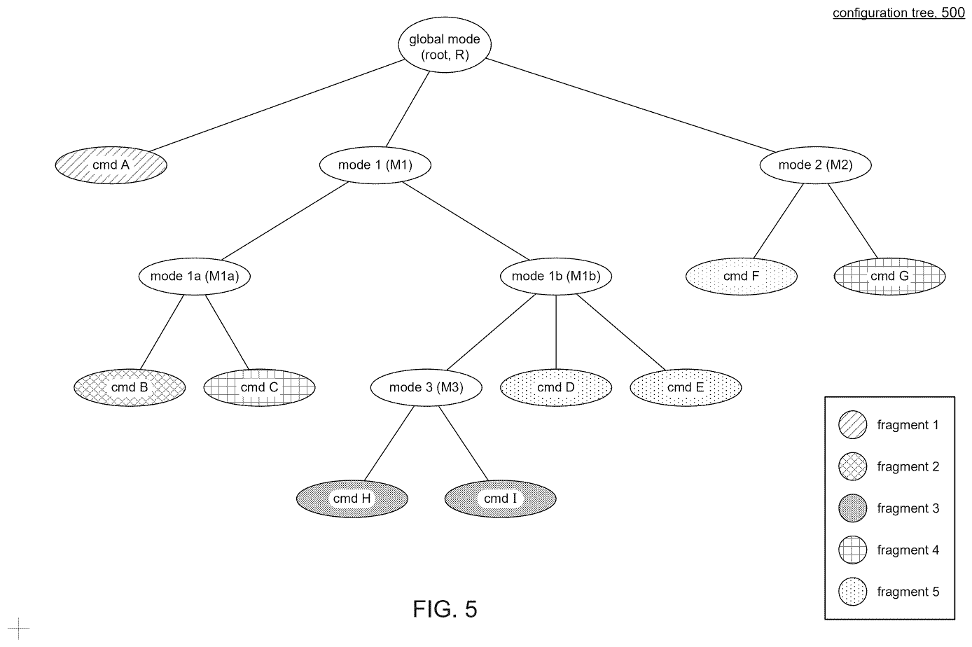

FIG. 5 shows an example configuration tree 500 that represents a generalized running configuration for a network device. As noted above, configuration tree 500 is a representation of the configuration modes and configuration commands that constitute a running configuration, where non-leaf nodes represent command modes and the leaf nodes represent the configuration commands (and the parameters/arguments of the command) entered in the given command mode. Merely to provide some context, consider the
M1, M1a→Cmd B, Cmd C
   subtree in FIG. 5. Suppose the “mode 1” sub-mode represents a mode to configure a specified group of ports (e.g., named “port Group 1”). The “mode 1a” sub-mode may represent a mode to configure a specified port (e.g., Ethernet1) in “port Group 1,” and the cmd B and cmd C leaf nodes would represent configuration commands for configuring the Ethernet1 port.

In accordance with some embodiments, a configuration fragment (fragment) can be expressed in terms of the configuration tree corresponding to the running configuration. More specifically, a configuration fragment can be a sub-tree of the configuration tree comprising a set of one or more branches, where a “branch” is defined as a path from the root to a leaf node (i.e., a configuration command). A fragment can be represented by the path information from the root to the leaf node. Following are examples of fragments of configuration tree 500:
fragment 1: R→[cmd A]
fragment 2: R→M1→M1a→[cmd B]
fragment 3: R→M1→M1b→M3→[cmd H] R→M1→M1b→M3→[cmd I]
fragment 4: R→M1→M1a→[cmd C] R→M2→[cmd G]
fragment 5: R→M1→M1b→[cmd D] R→M1→M1b→[cmd E] R→M2→[cmd F]

Fragments 1 and 2, each comprises a single branch in configuration tree 500. Fragment 1 comprises the branch defined by the path from the root directly to the configuration command at leaf node “cmd A.” Fragment 2 comprises the branch defined by the path R, M1, M1a to the configuration command at leaf node “cmd B.” Fragments 3-5 comprise multiple branches. Fragment 3 comprises a common branch from the root to the leaf node “cmd H” and from the root to the leaf node “cmd I,” and is deemed to be two branches. Fragments 4 and 5, each, comprises separate branches in the configuration tree; i.e., fragment 4 comprises two branches and fragment 5 comprises three branches.

As noted above, a leaf node may comprise more than one command. Consider fragment 1 above, for example, command A may represent a set of one or more configuration commands.

The configuration commands at the leaf nodes set the parameters of the running configuration, while the path information provides context for the commands, informing what data plane entities (interfaces, clocks, tables, etc.) the parameters apply to. Referring to FIG. 4B, for a moment, consider fragment 1 and fragment 2 for example. Both fragments include the SWITCHPORT configuration command. However, based on the path information, the SWITCHPORT configuration command in fragment 1 applies to the interface Ethernet1, whereas the SWITCHPORT configuration command in fragment 2 applies to the interface Ethernet2.

A given set of configuration fragments is said to represent the running configuration of the network device if the union of those fragments results in a configuration tree that represents the running configuration. For example, assume for the sake of discussion that configuration tree 500 represents the running configuration of a network device. The above example of fragments 1-5 represents the running configuration of the network device because the union of fragments 1-5 results in configuration tree 500.

In some embodiments, configuration fragments can be represented by a data structure referred to as CliSave models, disclosed in commonly owned U.S. app. Ser. No. 18/071,826 and incorporated herein by reference in its entirety. It will be appreciated, however, that in accordance with other embodiments of the present disclosure fragments can be represented by any suitable set of data structures. The data structures can be designed to optimize the performance of various fragment operations described below.

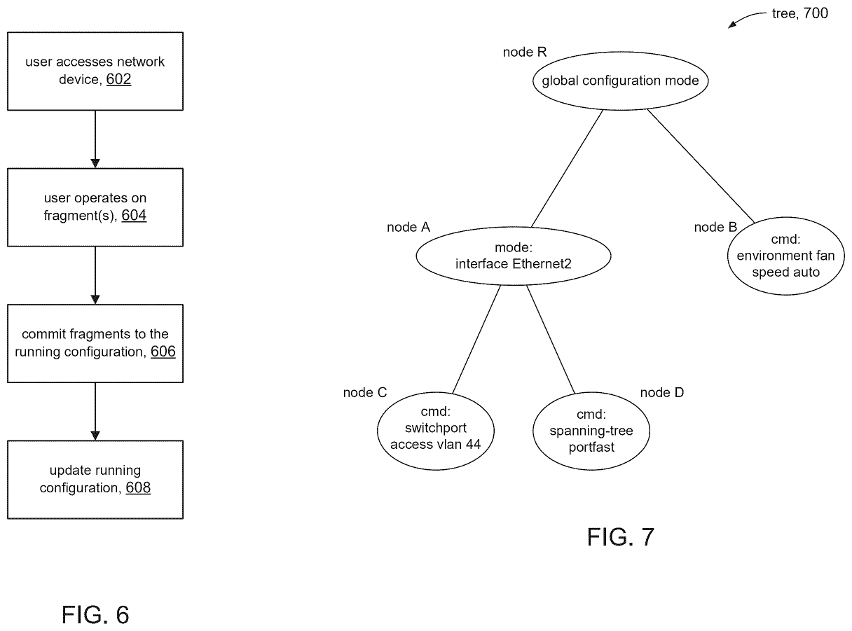

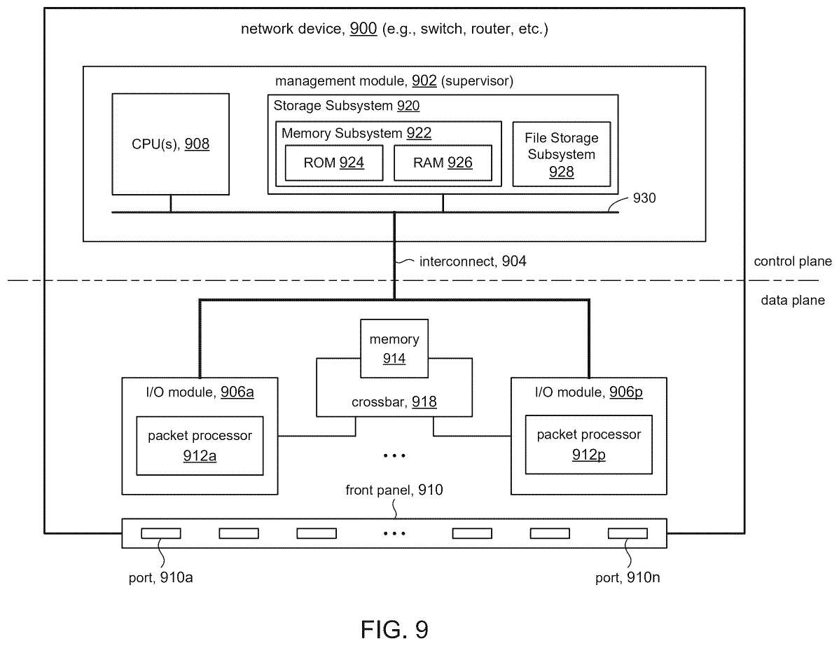

Referring to FIG. 6, the discussion will now turn to a high-level description of processing in a network device (e.g., 100, FIG. 1) to update (add, modify, delete) portions of the running configuration of the network device in accordance with the present disclosure. Depending on a given implementation, the processing may be performed entirely in the control plane or entirely in the data plane, or the processing may be divided between the control plane and the data plane. In some embodiments, the network device can include one or more processing units (circuits), which when operated, can cause the network device to perform processing in accordance with FIG. 6. Processing units (circuits) in the control plane, for example, can include general CPUs that operate by way of executing computer program code stored on a non-volatile computer readable storage medium (e.g., read-only memory); e.g., CPU 908 in the control plane (FIG. 9) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, each of the packet processors 912a-912p in the data plane (FIG. 9) can be a specialized processor.

The flow described below is a high-level representation of the operations and processing that can take place in a given embodiment in accordance with the present disclosure. The following operations/processing blocks are not necessarily executed in the order shown. Operations can be combined or broken out into smaller operations in various embodiments. Operations can be allocated for execution among one or more concurrently executing processes and/or threads, and so on.

At operation 602, the network device can give access to a user to operate on fragments of the running configuration of the network device. For example, a user can log onto the network device via a suitable interface such as a CLI (command line interface) to operate on fragments. As noted above, the user can be a human user or some kind of machine or automation such as a script from an internal or external source.

At operation 604, the network device can perform operations on the fragments in response to input from the user. For example, the user can call up existing fragments of the configuration tree that represents the running configuration. The configuration represented by the accessed fragment can be presented to the user. Referring to configuration tree 410 in FIG. 4B, for example, the configuration represented by fragment 1 can be presented to the user as:
interface Ethernet1
   switchport access vlan 33
   storm-control broadcast level 1
   spanning-tree portfast

### Spanning-Tree Bpduguard Enable

The sequence of mode selection commands and configuration commands corresponding to the accessed fragment of the running configuration can be presented to the user, for example, in a data file or on the CLI. For example, the following sequence of commands represents the above configuration:
switch #
switch #config
switch(config) #interface Ethernet1
switch(config-if-Et1) #switchport access vlan 33
switch(config-if-Et1) #storm-control broadcast level 1
switch(config-if-Et1) #spanning-tree portfast

In addition to accessing existing fragments of the running configuration, the user can create fragments to be added to the running configuration. For example, fragments can be created from a data file containing a sequence of mode selection commands and configuration commands. Fragments can be created from command sequences entered by the user, and so on. For example, referring to FIG. 7, the following user input:
switch #
switch #config
switch(config) #interface Ethernet2
switch(config-if-Et2) #switchport access vlan 44
switch(config-if-Et2) #spanning-tree portfast
switch(config) #exit
switch(config) #environment fan-speed auto
   can be represented as tree 700, and the configuration fragment would comprise the following branches:
R→A→command C
R43 A→command D
R→command B

At operation 606, the network device can commit one or more fragments specified by the user to the running configuration. The commit operation can proceed in accordance with the present disclosure as follows:
The network device can run a conflict check on the user-specified fragments to identify conflicts among the user-specified fragments. Additional details of the conflict check are discussed below. The network device can flag detected conflicts to allow the user to further edit their fragments to correct the conflicts.
If there are no conflicts, the user-specified fragments can then be merged to create a union configuration that represents the user-specified fragments. Additional details of the merge operation are discussed below.
A difference operation can be performed between the union configuration and corresponding portions of the running configuration. The difference operation generates a set of configuration commands that can update the corresponding portions of the running configuration to match the Union configuration.

At operation 608, the network device can update the running configuration by executing the set of configuration commands produced by the difference operation. Processing can be deemed complete.

The discussion will now turn to a description of the conflict check and merge operations in accordance with embodiments of the present disclosure. Recall from above that a configuration fragment comprises a set of one or more branches of a configuration tree, where a branch is defined as a path from the root of the tree to a configuration command at a leaf node. For discussion purposes, the following generalized notation will be used to represent a fragment:
Fragment: P1→C1, P2→C2, . . . Pn→Cn,
   where Pi is the pathname from the root of a configuration tree to configuration command Ci,
Ci is the configuration command,
the notation Pi→Ci can be referred to as a branch.

For discussion purposes, pathnames can be expressed with the slash notation that is commonly used for naming directories in a file system. Referring to FIG. 5, for example, fragment 1 has one branch with a pathname “/” (indicating the root node) and the configuration command “cmd A.” Fragment 4 comprises two branches: one branch having the pathname “/M1/M1a” and the configuration command “cmd C,” and another branch having the pathname “/M2” and the configuration command “cmd G.”

### Conflict Check

The conflict check operation determines whether two fragments conflict with each other. As explained above, as an initial step of the commit operation, the conflict check can be performed among the user-specified fragments to ensure that none of the users-specified fragments conflict with each other. In some embodiments, a conflict between two fragments (fragment 1, fragment 2) can be detected according to the following heuristic:
Compare each branch in fragment 1 with each branch in fragment 2.
For each branch (Pi→Ci) in fragment 1, if there is a branch (Pj→Cj) in fragment 2 that has the same pathname (Pj=Pi), then the two branches conflict if configuration command Ci (in fragment 1) is different from configuration command Cj (in fragment 2), and conversely the two branches do not conflict if configuration command Ci is the same as configuration command Cj. Branches in fragment 1 that do not have the same pathname as branches in fragment 2 do not conflict.
In accordance with the present disclosure, two instances of a configuration command (e.g., Ci, Ck) are deemed to be different if the two instances are invoked with different configuration parameters. As noted above, commands Ci and Cj may each contain a set of multiple commands, in which case we would consider the set of commands Ci and the set of commands Cj to be different if not all the commands in Ci and the commands in Cj are equal. Stated in the alternative, Ci and Cj are deemed to be the same if (1) Ci and Cj have the same set of constituent commands, (2) the execution order of the constituent commands is the same between Ci and Cj, and (3) each command in Ci is invoked with the same parameters as the corresponding command in Cj.
Refer to fragment 2 FIG. 4B and the fragment represented by configuration tree 700 in FIG. 7 for example:
   (fragment 2, FIG. 4B)
      B1: root→Ethernet2→[switchport access VLAN 44]
      B2: root→Ethernet2→[spanning tree portfast]
      B3: root→[environment fan speed auto]
   (tree 700, FIG. 7)
      B1: root→Ethernet2→[switchport access VLAN 66]
      B2: root→Ethernet2→[spanning tree portfast]
      B3: root→[environment fan speed auto]
Branch B2 in fragment 2 and branch B2 in tree 700 have the same pathname and invoke the configuration command SPANNING TREE with the same parameter, namely PORTFAST;
likewise for branch B3. Accordingly, there is no conflict between fragment 2 and tree 700 insofar as branches B2 and B3 are concerned.
On the other hand, although branch B1 in fragment 2 and branch B1 in tree 700 have the same pathname and invoke the same configuration command, namely SWITCHPORT ACCESS, the commands are invoked with different parameters: branch B1 in fragment 2 invokes the SWITCHPORT ACCESS configuration command with the parameter VLAN 44, and branch B1 in tree 700 invokes the SWITCHPORT ACCESS configuration command with the parameter VLAN 66.
Because the parameters between the two invocations of the configuration command are different with respect to branch B1, fragment 2 is deemed to be different from tree 700.
If a conflict exists, the operation can return an error and indicate the conflicting portion(s) of the two fragments, allowing the user(s) to correct the conflict. As noted above, the conflict check allows multiple independent users to access and modify different parts of the running configuration. By flagging conflicts and providing an opportunity to correct the conflicts, different portions of the running configuration can be concurrently modified by multiple users in a predictable manner without unexpected impact on remaining portions of the running configuration.

### Merge Two or More Fragments

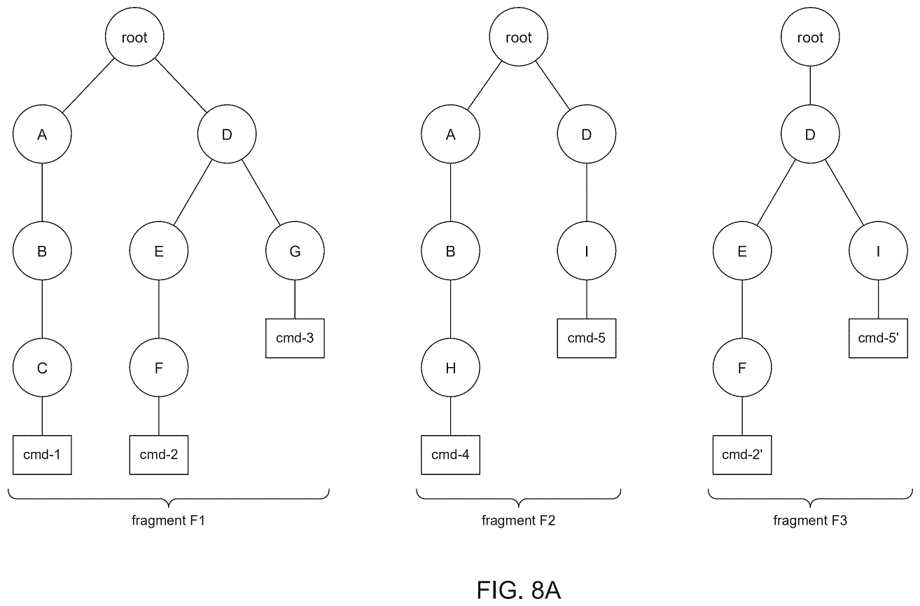

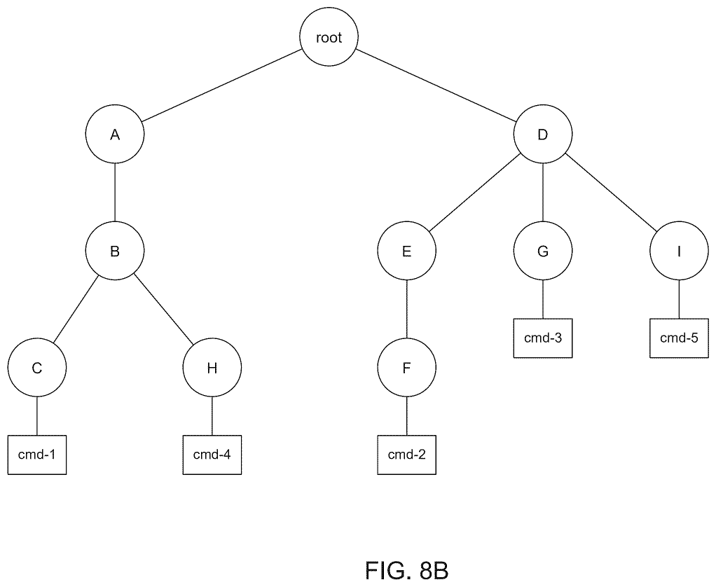

The merge operation combines constituent branches among the specified fragments to create a union configuration. The branches are combined according to their pathnames. Consider, for example, the following fragments shown in FIG. 8A:
F1: /A/B/C/cmd-1 /D/E/F/cmd-2 /D/G/cmd-3
F2: /A/B/H/cmd-4 /D/I/cmd-5
F3: /D/E/F/cmd-2′ /D/I/cmd-5′

FIG. 8B shows a configuration tree that represents the union configuration resulting from merging the above fragments.

The fragment examples shown above show that fragments can overlap. In accordance with the present disclosure, fragments are deemed to overlap if they share the same pathname to their respective leaf nodes. Fragments F1 and F3, for instance, share the same pathname (/D/E/F) to respective leaf nodes cmd-2 and cmd-2′. Likewise, fragments F2 and F3 share the same pathname (/D/I) to respective leaf nodes cmd-5 and cmd-5′.

This example illustrates a further example of conflicting fragments. Fragments F1 and F3 can be merged if there is no conflict between configuration command cmd-2 in fragment F1 and configuration command cmd-2′ in fragment F3; i.e., if cmd-2 and cmd-2′ specify the same configuration parameters. Likewise, fragments F2 and F3 can be merged if configuration command cmd-5 in fragment F2 specifies the same configuration parameters as configuration command cmd-5′ in fragment F3.

FIG. 9 is a schematic representation of a network device 900 (e.g., a router, switch, firewall, and the like) that can be adapted in accordance with the present disclosure. In some embodiments, for example, network device 900 can include one or more management modules 902, one or more I/O modules (switches, switch chips) 906a-906p, and a front panel 910 of I/O ports (physical interfaces, I/Fs) 910a-910n. Management module 902 can constitute the control plane of network device 900 (also referred to as the control layer or simply the central processing unit, CPU), and can include CPU(s) 908 for managing and controlling operation of network device 900 in accordance with the present disclosure. CPU(s) 908 can be a general-purpose processor, such as an Intel®/AMD® x86, ARM® microprocessor and the like, that operates under the control of software stored in a memory device/chips such as read-only memory (ROM) 924 or random-access memory (RAM) 926. The control plane provides services that include traffic management functions such as routing, security, load balancing, analysis, and the like.

CPU(s) 908 can communicate with storage subsystem 920 via bus subsystem 930. Other subsystems, such as a network interface subsystem (not shown in FIG. 9), may be on bus subsystem 930. Storage subsystem 920 can include memory subsystem 922 and file/disk storage subsystem 928. Memory subsystem 922 and file/disk storage subsystem 928 represent examples of non-transitory computer-readable storage devices that can store program code and/or data, which when executed by CPU(s) 908, can cause CPU(s) 908 to perform operations in accordance with embodiments of the present disclosure.

Memory subsystem 922 can include a number of memories such as main RAM 926 (e.g., static RAM, dynamic RAM, etc.) for storage of instructions and data during program execution, and ROM (read-only memory) 924 on which fixed instructions and data can be stored. File storage subsystem 928 can provide persistent (i.e., non-volatile) storage for program and data files, and can include storage technologies such as solid-state drive and/or other types of storage media known in the art.

CPU(s) 908 can run a network operating system stored in storage subsystem 920. A network operating system is a specialized operating system for network device 900. For example, the network operating system can be the Arista EOS® operating system, which is a fully programmable and highly modular, Linux-based network operating system developed and sold/licensed by Arista Networks, Inc. of Santa Clara, California. It is understood that other network operating systems may be used.

Bus subsystem 930 can provide a mechanism for the various components and subsystems of management module 902 to communicate with each other as intended. Although bus subsystem 930 is shown schematically as a single bus, alternative embodiments of the bus subsystem can utilize multiple buses.

The one or more I/O modules 906a-906p can be collectively referred to as the data plane of network device 900 (also referred to as the data layer, forwarding plane, etc.). Interconnect 904 represents interconnections between modules in the control plane and modules in the data plane. Interconnect 904 can be any suitable bus architecture such as Peripheral Component Interconnect Express (PCIe), System Management Bus (SMBus), Inter-Integrated Circuit (I2C), etc.

I/O modules 906a-906p can include respective packet processing hardware comprising packet processors 912a-912p (collectively 912) to provide packet processing and forwarding capability. Each I/O module 906a-906p can be further configured to communicate over one or more ports 910a-910n on the front panel 910 to receive and forward network traffic. Packet processors 912 can comprise hardware (circuitry), including for example, data processing hardware such as an application specific integrated circuit (ASIC), field programmable gate array (FPGA), processing unit, and the like, which can be configured to operate in accordance with the present disclosure. Packet processors 912 can include forwarding lookup hardware such as, for example, but not limited to content addressable memory such as ternary CAMs (TCAMs) and auxiliary memory such as static RAM (SRAM).

Memory hardware 914 can include buffers used for queueing packets. I/O modules 906a-906p can access memory hardware 914 via crossbar 918. It is noted that in other embodiments, the memory hardware 914 can be incorporated into each I/O module. The forwarding hardware in conjunction with the lookup hardware can provide wire speed decisions on how to process ingress packets and outgoing packets for egress. In accordance with some embodiments, some aspects of the present disclosure can be performed wholly within the data plane.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method for updating a running configuration of a network device, wherein the running configuration represents current settings of configurable elements of the network device, the method comprising:
modifying a plurality of configuration fragments, each configuration fragment associated with a subset of the configurable elements of the network device and comprising one or more configuration commands to configure the subset of the configurable elements;
detecting conflicts between the modified configuration fragments;
reporting any detected conflicts among the modified configuration fragments; and
updating the running configuration with the modified configuration fragments, including:
merging the modified configuration fragments to produce a union configuration;
generating a set of configuration commands based on differences between the union configuration and corresponding portions of the running configuration; and
executing the generated set of configuration commands to update the corresponding portions of the running configuration to match the union configuration.

2. The method of claim 1, wherein a conflict exists between a first fragment and a second fragment when the first and second fragments contain configuration commands to configure an element of the network device with different settings.

3. The method of claim 1, wherein the plurality of configuration fragments includes a copy of a fragment of the running configuration, wherein the method further includes modifying the copy of the fragment of the running configuration.

4. The method of claim 1, wherein the plurality of configuration fragments includes a new fragment that is not a fragment of the running configuration.

5. The method of claim 1, further comprising receiving input from a user to edit a modified configuration fragment that is deemed to be in conflict with another of the modified configuration fragments.

6. The method of claim 1, wherein the running configuration is associated with a configuration tree, wherein leaf nodes represent configuration commands to configure the elements of the network device, wherein non-leaf nodes represent configuration modes that specify the elements of the network device, wherein the modified configuration fragments are expressed as paths within the configuration tree.

7. The method of claim 6, wherein a modified configuration fragment is deemed to be in conflict with the running configuration when the configuration commands of the modified configuration fragment do not match the configuration commands of the leaf node in the configuration tree whose path matches the path of the modified configuration fragment in terms of settings of the configuration commands and ordering of the configuration commands.

8. A network device comprising:
one or more computer processors; and
a computer-readable storage device comprising instructions for controlling the one or more computer processors to:
modify a plurality of configuration fragments, each configuration fragment associated with a subset of the configurable elements of the network device and comprising one or more configuration commands to configure the subset of the configurable elements;
detect conflicts between the modified configuration fragments;
report any detected conflicts among the modified configuration fragments; and
update the running configuration with the modified configuration fragments, including:
merging the modified configuration fragments to produce a union configuration;
generating a set of configuration commands based on differences between the union configuration and corresponding portions of the running configuration; and
executing the generated set of configuration commands to update the corresponding portions of the running configuration to match the union configuration.

9. The network device of claim 8, wherein a conflict exists between a first fragment and a second fragment when the first and second fragments contain configuration commands to configure an element of the network device with different settings.

10. The network device of claim 8, wherein the plurality of configuration fragments includes a copy of a fragment of the running configuration, wherein the method further includes modifying the copy of the fragment of the running configuration.

11. The network device of claim 8, wherein the plurality of configuration fragments includes a new fragment that is not a fragment of the running configuration.

12. The network device of claim 8, wherein the computer-readable storage device further comprises instructions for controlling the one or more computer processors to receive input from a user to edit a modified configuration fragment that is deemed to be in conflict with another of the modified configuration fragments.

13. The network device of claim 8, wherein wherein the running configuration is associated with a configuration tree, wherein leaf nodes represent configuration commands to configure the elements of the network device, wherein non-leaf nodes represent configuration modes that specify the elements of the network device, wherein the modified configuration fragments are expressed as paths within the configuration tree.

14. The network device of claim 13, wherein a modified configuration fragment is deemed to be in conflict with the running configuration when the configuration commands of the modified configuration fragment do not match the configuration commands of the leaf node in the configuration tree whose path matches the path of the modified configuration fragment in terms of settings of the configuration commands and ordering of the configuration commands.

15. A non-transitory computer-readable storage device in a network device, the non-transitory computer-readable storage device having stored thereon computer executable instructions, which when executed, cause the network device to:
modify a plurality of configuration fragments, each configuration fragment associated with a subset of the configurable elements of the network device and comprising one or more configuration commands to configure the subset of the configurable elements;
detect conflicts between the modified configuration fragments;
report any detected conflicts among the modified configuration fragments; and
update the running configuration with the modified configuration fragments, including:
merging the modified configuration fragments to produce a union configuration;
generating a set of configuration commands based on differences between the union configuration and corresponding portions of the running configuration; and
executing the generated set of configuration commands to update the corresponding portions of the running configuration to match the union configuration.

16. The non-transitory computer-readable storage device of claim 15, wherein a conflict exists between a first fragment and a second fragment when the first and second fragments contain configuration commands to configure an element of the network device with different settings.

17. The non-transitory computer-readable storage device of claim 15, wherein the plurality of configuration fragments includes a copy of a fragment of the running configuration, wherein the method further includes modifying the copy of the fragment of the running configuration.

18. The non-transitory computer-readable storage device of claim 15, wherein the plurality of configuration fragments includes a new fragment that is not a fragment of the running configuration.

19. The non-transitory computer-readable storage device of claim 15, wherein the computer-readable storage device further comprises instructions for controlling the one or more computer processors to receive input from a user to edit a modified configuration fragment that is deemed to be in conflict with another of the modified configuration fragments.

20. The non-transitory computer-readable storage device of claim 15, wherein the running configuration is associated with a configuration tree, wherein leaf nodes represent configuration commands to configure the elements of the network device, wherein non-leaf nodes represent configuration modes that specify the elements of the network device, wherein the modified configuration fragments are expressed as paths within the configuration tree, wherein a modified configuration fragment is deemed to be in conflict with the running configuration when the configuration commands of the modified configuration fragment do not match the configuration commands of the leaf node in the configuration tree whose path matches the path of the modified configuration fragment in terms of settings of the configuration commands and ordering of the configuration commands.
